(19) United States
(12) Patent Application Publication
(10) Pub. No.: US 2024/0301298 A1
(43) Pub. Date: Sep. 12, 2024

(54) System and Method to Remove Impurities from Oil

(71) Applicant: Clean Science Systems, LLC, Plano, TX (US)

(72) Inventor: David Pickett, Plano, TX (US)

(21) Appl. No.: 18/599,149

(22) Filed: Mar. 7, 2024

Related U.S. Application Data
(60) Provisional application No. 63/450,478, filed on Mar. 7, 2023.

(51) Int. Cl. C10G 45/26; C02F 1/44; C02F 103/36

(52) U.S. Cl. CPC C10G 45/26; C02F 1/441; C02F 2103/365; C10G 2300/205

(57) ABSTRACT

A system and method for removing impurities from oil may be a continuous process may be provided where crude oil may be purified as it flows from the well formation or a tank of impure oil may be purified with no dwell time before it is transported to and sold to a refinery. A centrifugal pump may mix impure oil having included impurities with pure water that may have added chemicals such as a surfactant, flocculant, or other chemicals. The impure oil and the pure water with added surfactant and other chemicals may be pumped under pressure into a settling tank where the water and oil may naturally separate. The high-pressure pump may break up the large oil globules into smaller globules. The impurities in the oil may separate the oil's included impurities into the pure water until impurity equilibrium is attained between the impure oil and the water.

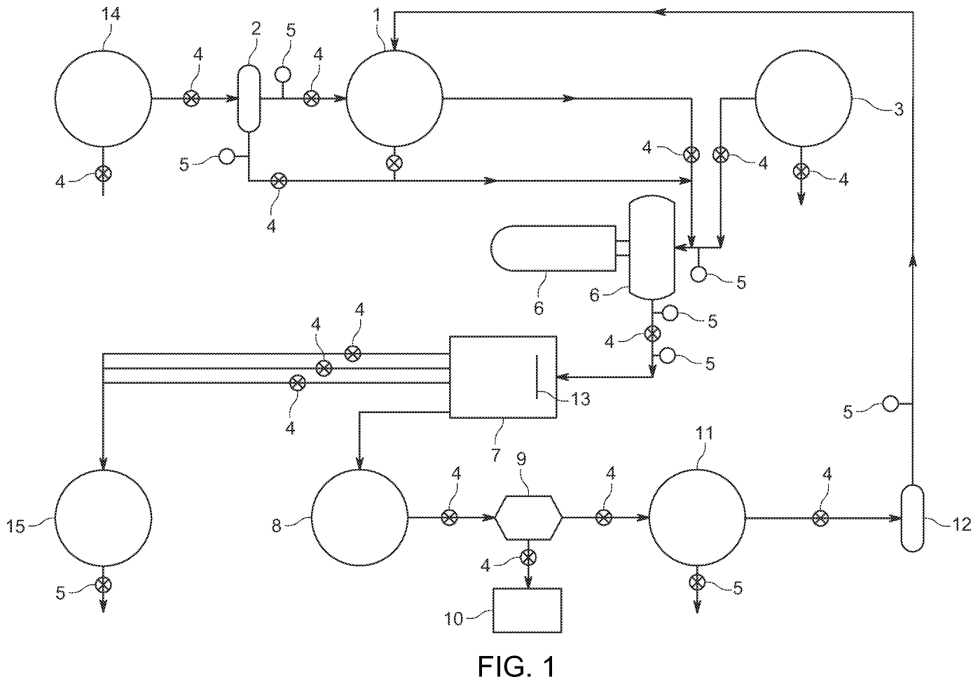

### CROSS-REFERENCE TO RELATED APPLICATION

The present application is a non-provisional of, and claims priority to, U.S. patent application Ser. No. 63/450,478, filed Mar. 7, 2023, the disclosure of which is incorporated by reference in its entirety.

### FIELD OF THE DISCLOSURE

The present disclosure generally relates removal of impurities from oil, and more particularly to a continuous, scalable system and method for economical removal of impurities from oil.

### BACKGROUND

Crude oil as it is removed from a formation may have many impurities. Some crude oil may have impurities that a refinery must remove before further refining the crude oil into useful commodities. The removal of some impurities, such as included metals, may be expensive and well operators may be motivated to remove the impurities at a lower cost before selling the oil to a refinery. Current impurity removal processes may include adding flocculants to the impure oil and holding the mixture in a tank until impurities may settle out onto the bottom of the tank. This process may require operators to have large storage tanks where batches of impure oil may stay for days while the impurities settle out. This process may be largely uncontrolled, and the process may have to be repeated until the oil reaches the necessary purity. The processing chemicals are expended and may have to be replaced as they are expended and not recycled. This tank-bottom sludge may be sold to specialty operators who then have processes to remove the impurities and recover pure crude, which in turn may be sold to refineries.

### SUMMARY

Embodiments of the present disclosure may provide a system and method for removing impurities from oil. A continuous process may be provided where crude oil may be purified as it flows from a well formation in an embodiment of the present disclosure. In another embodiment of the present disclosure, a continuous process may purify a tank of impure oil with no dwell time before it is transported to and sold to a refinery.

A centrifugal pump may mix impure oil having included impurities with pure water that may have added chemicals such as a surfactant, flocculant, and/or other chemicals. Adding surfactant to the oil globules may reduce the affinity for smaller oil globules to rejoin into larger oil globules. Surfactant may reduce the surface tension of the impurities so that the impurities may no longer stick to the oil globules or each other. The impure oil and the pure water with added surfactant, flocculant, and/or other chemicals may be pumped under pressure through an orifice or expansion port into a settling tank where the water and oil may naturally separate because oil and water will not mix; they are immiscible. The high-pressure pump may break up the large oil globules into smaller globules. The pressure drop across the expansion port may break up large oil globules into smaller globules.

Through natural equilibrium, the impurities in the oil may separate the oil's included impurities into the pure water until impurity equilibrium may be attained between the impure oil and the water. Oil impurities may contain salts which the system and method according to embodiments of the present disclosure may remove, transferring salts to the water mixture in the process. The oil purification process may be repeated until the desired levels of impurities in the processed oil may be attained. The water with impurities may be purified and reused or disposed of properly. The impurities from the water may be sold or disposed of properly. Impurities may be harvested from back flushing RODI cartridges if RODI is used to purify the process water for reusing/recycling in the process. The oil purification process equipment may be portable or permanently mounted at a well, multiple wells or at an oil storage facility.

Other embodiments of the present disclosure may provide a system for removing impurities from oil comprising: a pure water tank that may receive chemicals to produce treated pure water; an impure oil tank containing impure oil having included impurities; a high-pressure centrifugal pump that may receive the impure oil from the impure oil tank and the treated pure water from the pure water tank, wherein upon receipt, pressure in the high-pressure centrifugal pump may be increased from 50 to 600 PSI and the impure oil and the treated pure water may be mixed to form a treated impure oil/pure water combination; a settling tank that may receive the treated impure oil/pure water combination from the high-pressure centrifugal pump through an expansion port that introduces a pressure drop, wherein water and oil within the treated impure oil/pure water combination may separate and the included impurities break away from oil globules in the pressure drop and the oil globules reduce in size; a water purification system that may purify water separated from the impure oil/pure water combination; and a pump provided to move the purified water to the pure water tank to reuse in oil purification. The pure water tank may receive chemicals through direct addition and/or through the chemicals passing through a ball valve to a pump. The chemicals may include a surfactant to lessen surface tension of oil globules and the included impurities. The chemicals also may include a flocculant that causes solids and the included impurities to settle out of the impure oil by gravity or centrifugal force. The system also may include a process tank baffle within the settling tank. The water purification system may purify water through reverse osmosis deionization (RODI) which removes impurities from the water to produce purified water that is capable of being reused in an oil purification process. The water purification system may purify water through steam distillation. The system may be portable and/or may be permanently mounted at a well, multiple wells, and/or at an oil storage facility.

Further embodiments of the present disclosure may provide a method for removing impurities from oil comprising: using a centrifugal pump, mixing impure oil having included impurities with pure water including at least one surfactant that reduces affinity for smaller oil globules to rejoin into larger oil globules and reduces surface tension of the included impurities so they do not stick to the oil globules or to each other, the mixing resulting in a treated impure oil/pure water combination; pumping the treated impure oil/pure water combination under pressure through an expansion port having a pressure drop into a settling tank, wherein water and oil separate until impurity equilibrium is attained between the oil and the water; purifying water separated from the treated impure oil/pure water combination; transferring the purified water to a tank containing the pure water; and repeating the mixing, pumping, and purifying steps until a threshold level of impurities in the processed oil is attained. The pure water also may include a flocculant. The purifying step may purify water through reverse osmosis deionization (RODI) which removes impurities from the water to produce purified water that is capable of being reused in an oil purification process. The purifying step may purify water through steam distillation. The method also may include testing the separated oil to determine level of impurities remaining prior to another pass in an oil purification process. The method may further include prior to the mixing step, removing unwanted water in the impure oil having included impurities. The method also may include isolating additives in the water separated from the treated impure oil/pure water combination to be reclaimed and reused. The method may further include evaporating impure water in the water separated from the treated impure oil/pure water combination to remove water from impurities for use in an oil purification process.

### BRIEF DESCRIPTION OF THE DRAWING

For a more complete understanding of this disclosure, reference is now made to the following description, taken in conjunction with the accompanying drawing, in which:

The FIGURE depicts a system to remove impurities from oil according to an embodiment of the present disclosure.

### DETAILED DESCRIPTION

Embodiments of the present disclosure may provide a system and method to remove impurities from oil. Oil may naturally exist not as individual molecules, but as large globules of oil molecules as described herein.

The FIGURE depicts a system to remove impurities from oil according to an embodiment of the present disclosure. A tank for chemicals 14 for pure water tank 1 may be provided with ball valves 4. It should be appreciated that chemicals 14 may be added to pure water tank 1 directly or the chemicals may be in a separate tank where a pump may measure the correct amount of chemicals into the pressure pump suction tube during operation without departing from the present disclosure.

Pump 2 may be provided to add chemicals 14 to pure water tank 1. Chemicals 14 may pass through ball valve 4 to pump 2. Pressure gauge 5 may be provided between pump 2 and pure water tank 1. Ball valve 4 also may be provided between pump 2 and pure water tank 1. Impure oil tank 3 may be provided to transfer impure oil to high pressure centrifugal pump 6. This path of transfer may include ball valve 4 and may include pressure gauge 5 in an embodiment of the present disclosure. Impure oil may be released from tank 3 through a path having ball valve 4 in an embodiment of the present disclosure.

Pressure gauge 5 also may be provided between pump 2 and high-pressure centrifugal pump 6. The impure oil and treated pure water enter centrifugal pump 6 where the pressure may be increased from 50 to 600 PSI. High-pressure centrifugal pump 6 may mix impure oil with included impurities with pure water that may have a surfactant added and optional flocculant and other optional chemicals. Surfactants may lessen the surface tension of oil globules. Surfactants also may lessen the surface tension of the impurities. Flocculants may cause solids and impurities to settle out of the oil by gravity or centrifugal force.

Impure oil and pure water with added surfactant and optional other chemicals may be pumped under high pressure through an orifice or expansion port into a settling tank (tank 7 as described herein) where the water and oil will naturally separate because oil and water will not mix; they are immiscible. High-pressure pump 6 may break up the large oil globules into smaller globules. This high-pressure mixture may pass through an orifice or expansion device where the fluid pressure drops. The pressure drop across the expansion port may break up large oil globules into smaller globules. This pressure drop may be explosive and may cause the oil molecular globules to break into smaller globules.

The presence of a surface-tension-defeating surfactant may reduce the surface tension between the oil molecules in the globules and may result in smaller oil globules. The presence of a surface-tension-defeating surfactant may cause the smaller oil globules from rejoining into larger oil globules. The pressure drop may break away impurities from the globules of oil. The pressure drop may reduce the size of the globules of oil. The presence of a surface-tension-defeating surfactant may not allow the impurities to stick to the oil globules and may release impurities from the globules of oil. The presence of a flocculant may cause the impurities to disassociate from the oil globules and settle out of the mixture by gravity or centrifugal force.

Adding a surfactant to the oil globules may reduce the affinity for smaller globules to rejoin into larger globules. The surfactant may reduce the surface tension of the impurities so that the impurities may no longer stick to the oil globules. Through natural equilibrium, the impurities in the oil may separate the oil's included impurities into the pure water until impurity equilibrium may be attained between the oil and the water. The impurities may be disassociated from the oil globules and may combine with the pure water, by way of equilibrium, until the impurity percentage in the water may equal the impurities percentage in the oil in an embodiment of the present disclosure.

Ball valve 4 also may be provided between pump 2 and high-pressure centrifugal pump 6 as well as between pure water tank 1 and high-pressure centrifugal pump 6. One or more pressure gauges 5 may be provided between high-pressure centrifugal pump 6 and tank 7. Ball valve 4 also may be provided between high-pressure centrifugal pump 6 and tank 7. Tank 7 may be where oil and water separate in an embodiment of the present disclosure. Process tank baffle 13 may be provided within tank 7.

Processed oil may travel through one or more paths to processed oil tank 15. Each of the paths may include ball valve 4 in an embodiment of the present disclosure. Pressure gauge 5 may be provided in removal of processed oil from tank 15. Impure water may be moved to impure water tank 8 from tank 7.

Water purification system 9 may then be employed on impure water from tank 8. Water may be purified with reverse osmosis deionization (RODI), steam distillation, or other similar processes in embodiments of the present disclosure. In a RODI process, backflushing the RODI canisters may remove the impurities which may be sold or disposed of, and the purified water reused in the oil purification process. After each pass through the RODI or other water purification process, the water may be tested to determine the level of impurities to determine if the water may require another pass through the water purification process. The water may be purified by steam distillation or other processes wherein the impurities may be removed or separated from the impure water and the purified water reclaimed for reuse in the oil purification process.

Ball valve may be provided on a path between tank 8 and water purification system 9 in an embodiment of the present disclosure. Impurities may be removed following use of water purification system 9, and impurities may be placed in impurities tank 10. Ball valve 4 may be provided between water purification system 9 and impurities tank 10.

Pure water resulting from water purification system 9 may be placed in pure water tank 11. Ball valve 4 may be provided between water purification system 9 and pure water tank 11. Pressure gauge 5 may be provided in removal of pure water from tank 11. Pump 12 may be provided to move pure water from tank 11 back into the oil purification process. Ball valve 4 may be provided between tank 11 and pump 12 in an embodiment of the present disclosure.

As depicted herein, the oil purification process may be reengaged through transfer of water from pump 12 to pure water tank 1. Pressure gauge 5 may be provided between pump 12 and pure water tank 1 in an embodiment of the present disclosure. Once the transfer to pure water tank 1 has occurred, the steps described above in the oil purification process may be repeated. The oil purification process may be repeated until the desired levels of impurities in the processed oil is attained. After each pass through the oil purification process, the oil may be tested to determine the level of impurities to determine if the oil may require another pass through the process.

The oil purification process equipment may be portable or permanently mounted at a well, multiple wells, and/or at an oil storage facility in embodiments of the present disclosure. Repeating the oil purification process may reduce the impurities in the oil with each pass through the process until the level of impurities in the oil may reach a predetermined, desirable, acceptable level in embodiments of the present disclosure.

It should be appreciated that before processing takes place, unwanted water in the contaminated oil may be removed by one or more processes to remove water from oil at the well head or thereafter. It also should be appreciated that the system and process described herein may remove salts from oil. Water having impurities may be processed, purified, and reused or disposed of properly in embodiments of the present disclosure. Similarly, impurities from the water may be reclaimed and sold or disposed of properly in embodiments of the present disclosure. The impure water may be evaporated to result in removal of water from the impurities. The additives in the water may be reclaimed and reused or disposed of properly. The metals in the impure water may be valuable and sold. Worthless impurities in the impure water may be disposed of properly.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for removing impurities from oil comprising:
a pure water tank that receives chemicals to produce treated pure water;
an impure oil tank containing impure oil having included impurities;
a high-pressure centrifugal pump that receives the impure oil from the impure oil tank and the treated pure water from the pure water tank, wherein upon receipt, pressure in the high-pressure centrifugal pump is increased from 50 to 600 PSI and the impure oil and the treated pure water are mixed to form a treated impure oil/pure water combination;
a settling tank that receives the treated impure oil/pure water combination from the high-pressure centrifugal pump through an expansion port that introduces a pressure drop, wherein water and oil within the treated impure oil/pure water combination separate and the included impurities break away from oil globules in the pressure drop and the oil globules reduce in size;
a water purification system that purifies water separated from the impure oil/pure water combination; and
a pump provided to move the purified water to the pure water tank to reuse in oil purification.

2. The system of claim 1, wherein the pure water tank receives chemicals through direct addition.

3. The system of claim 1, wherein the pure water tank receives chemicals through the chemicals passing through a ball valve to a pump.

4. The system of claim 1, wherein the chemicals include a surfactant to lessen surface tension of oil globules and the included impurities.

5. The system of claim 4, wherein the chemicals also include a flocculant that causes solids and the included impurities to settle out of the impure oil by gravity or centrifugal force.

6. The system of claim 1 further comprising:
a process tank baffle within the settling tank.

7. The system of claim 1, wherein the water purification system purifies water through reverse osmosis deionization (RODI) which removes impurities from the water to produce purified water that is capable of being reused in an oil purification process.

8. The system of claim 1, wherein the water purification system purifies water through steam distillation.

9. The system of claim 1, wherein the system is portable.

10. The system of claim 1, wherein the system is permanently mounted at a well, multiple wells, and/or at an oil storage facility.

11. A method for removing impurities from oil comprising:
using a centrifugal pump, mixing impure oil having included impurities with pure water including at least one surfactant that reduces affinity for smaller oil globules to rejoin into larger oil globules and reduces surface tension of the included impurities so they do not stick to the oil globules or to each other, the mixing resulting in a treated impure oil/pure water combination;
pumping the treated impure oil/pure water combination under pressure through an expansion port having a pressure drop into a settling tank, wherein water and oil separate until impurity equilibrium is attained between the oil and the water;
purifying water separated from the treated impure oil/pure water combination;
transferring the purified water to a tank containing the pure water; and
repeating the mixing, pumping, and purifying steps until a threshold level of impurities in the processed oil is attained.

12. The method of claim 11, wherein the pure water also includes a flocculant.

13. The method of claim 11, wherein the purifying step purifies water through reverse osmosis deionization (RODI) which removes impurities from the water to produce purified water that is capable of being reused in an oil purification process.

14. The method of claim 11, wherein the purifying step purifies water through steam distillation.

15. The method of claim 11 further comprising:
testing the separated oil to determine level of impurities remaining prior to another pass in an oil purification process.

16. The method of claim 11 further comprising:
prior to the mixing step, removing unwanted water in the impure oil having included impurities.

17. The method of claim 11 further comprising:
isolating additives in the water separated from the treated impure oil/pure water combination to be reclaimed and reused.

18. The method of claim 11 further comprising:
evaporating impure water in the water separated from the treated impure oil/pure water combination to remove water from impurities for use in an oil purification process.
